(19) United States
(12) Patent Application Publication
(10) Pub. No.: US 2007/0266637 A1
(43) Pub. Date: Nov. 22, 2007

(54) Container with automatic opening feature

(75) Inventor: Joseph L. McGowan, Saint Charles, MO (US)

Correspondence Address: HOGAN & HARTSON L.L.P., 1999 AVENUE OF THE STARS, SUITE 1400, LOS ANGELES, CA, 90067, US

(73) Assignee: HOME ETC.

(21) Appl. No.: 11/400,645

(22) Filed: Apr. 6, 2006

(51) Int. Cl. E05F 15/16; B65D 55/00

(52) U.S. Cl. 49/349; 220/211; 220/908

(57) ABSTRACT

The present invention is directed to a cover for a container. The cover includes a moveable member and a motor having armature connected to the moveable member. A sensor generates a sensing signal when motion is detected. A controller is connected to the sensor and the motor. The controller receives the sensing signal from the sensor and activates the motor to move the moveable member from a closed position to an opened position. After a predetermined period of time, the controller deactivates the motor to move the moveable member from the opened position to the closed position.

### BACKGROUND OF THE INVENTION

1. Field of the Invention

The present invention relates to a container with an automatic opening feature.

2. Description of Related Art

Some conventional containers, such as trash cans or containers, have a manually operated lid that allows a user to discard waste, trash or debris. In one example, a conventional trash can has a manually operated lid that covers a hollow interior portion of the trash can that must be pushed or pulled open by the user before waste can be discarded. Another example of a conventional trash can requires a user to step on a lever that opens the lid so that waste can be discarded.

These types of conventional trash cans require the user to touch a portion of the trash can prior to discarding waste. In general, touching the trash can may lead to the spread of bacteria, contaminants and infectious diseases. In addition, disabled persons may not be able to manually operate these conventional trash cans or containers without assistance.

### SUMMARY OF THE INVENTION

In one embodiment, the present invention is directed to a container, such as, for example, a trash container, having a cover with an automatic opening feature. The container includes a cover having a moveable member. A motor having armature is connected to the moveable member. A sensor generates a sensing signal when motion by a user is detected. A controller is connected to the sensor and the motor. The controller receives the sensing signal from the sensor and activates the motor to move the moveable member from a closed position to an opened position. After a predetermined period of time, the controller deactivates the motor to move the moveable member from the opened position to the closed position.

In another embodiment, the present invention is directed to a cover for a container having an automatic opening feature. The cover for the container includes a moveable member and a motor having armature connected to the moveable member. A sensor generates a sensing signal when motion by a user is detected. A controller is connected to the sensor and the motor. The controller receives the sensing signal from the sensor and activates the motor to move the moveable member from a closed position to an opened position. After a predetermined period of time, the controller deactivates the motor to move the moveable member from the opened position to the closed position.

In one aspect, the moveable member rotates about a pivot point when moving from the closed position to the opened position or vice versa. Alternately, in another aspect, the moveable member slides along a guide when moving from the closed position to the opened position and vice versa.

It should be appreciated by those skilled in the art that the container of the present invention may comprise various types of containers, such as, for example, a trash container or various other types of containers, having the automatic opening feature without departing from the scope of the present invention.

Other features and advantages of the invention will be apparent from the following detailed description, taken in conjunction with the accompanying drawings which illustrate, by way of example, various features of embodiments of the present invention.

### BRIEF DESCRIPTION OF THE DRAWINGS

FIG. 1 is a perspective view of one embodiment of a container having a cover.

FIGS. 2A-2C are various views of one embodiment of the cover with a moveable member.

FIG. 3 is a perspective view of a pivot assembly.

FIG. 4A is a perspective view of an inner container of the container.

FIG. 4B is a cross-sectional side view of a liner secured to inner container.

FIG. 4C is a cross-sectional side view of a closed end of the inner container.

FIG. 5 is a diagram of a control system for the container.

FIG. 6 is a perspective view of another embodiment of a container having a cover.

FIGS. 7A-7C are various views of another embodiment of a cover with a moveable member.

### DETAILED DESCRIPTION OF THE INVENTION

Reference will now be made to the drawings wherein like numerals refer to like parts throughout.

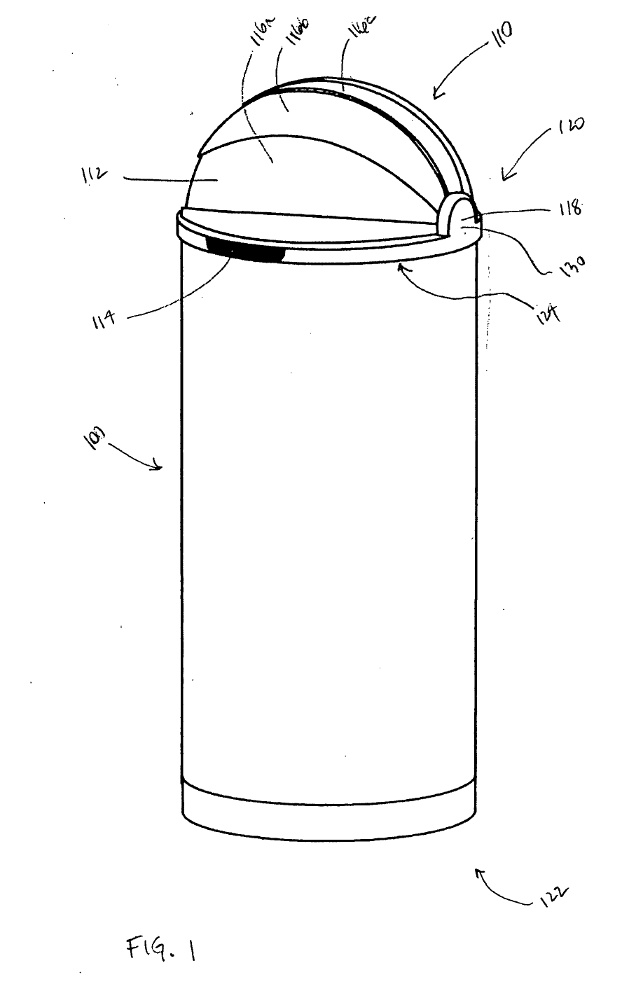

FIG. 1 is a perspective view of a container 100, such as, for example, a trash container, having a cover or lid 110 with a moveable member 112 and a sensor 114. In one embodiment, container 100 comprises a cylindrical shape with a hollow interior region, an open end 120, and a closed end 122. Open end 120 is adapted to allow a trash liner or bag to be positioned within container 100, and open end 120 is also adapted to receive cover 110 around an upper edge 124 of container 100. Closed end 122 encloses container 100 at the bottom to prevent trash and debris from exiting container 100 from the bottom, and closed end 122 is typically positioned adjacent to the floor or ground to provide a stable base that allows container 100 to stand upright as shown in FIG. 1. In one embodiment, cover 110 and moveable member 112 comprise a semi-hemispherical or domed shape.

It should be appreciated by those skilled in the art that container 100 may comprise various types of containers, such as, for example, a trash container, a fishing tackle live well, a diaper pail or a sharps container, having the automatic opening feature without departing from the scope of the present invention. In general, the present invention may include other various types of generally known containers, including general purpose containers, having the automatic opening feature without departing from the scope of the present invention.

In one embodiment, moveable member 112 comprises one or more moveable members, sections or panels 116a, 116b, 116c that are connected to a pivot assembly 130 and rotate about a pivot point 118 from a closed or deployed position, as shown in FIG. 1, to an opened or retracted position to thereby provide an opening or access to the hollow interior region of container 100. Moveable member 112, including moveable members 116a, 116b, 116c, can also rotate about pivot assembly 130, which provides pivot point 118, from the opened position to the closed position, as shown in FIG. 1, to thereby seal or cover the opening or prevent access to the hollow interior region of container 100. In one aspect, when in the opened or closed position, each moveable member 116a, 116b, 116c overlaps the adjacent member to form a sealed cover or lid.

In one embodiment, sensor 114 comprises, for example, an infrared (IR) motion sensor or detector that is adapted to sense or detect motion or movement adjacent to or in front of container 100 at a position adjacent to or in front of sensor 114. In one aspect, sensor 114 may comprise one or more sensors that have a predetermined sensing range and arc, such as, for example, approximately 5 to 12 inch sensing range on a 140° sensing arc in front proximity of sensor 114. It should be appreciated by those skilled in the art that sensor 114 may comprise various types of generally known sensors, such as, for example, a sound or voice activated sensor, without departing from the scope of the present invention.

In one aspect, sensor 114 allows for hands-free opening and closing of container 100. This is an advantage when the user has other objects occupying their hands at the time of use. In one example, motion or movement includes waving a hand or other object in proximity to sensor 114. This is advantageous for health in the home, hospital, office, and other various locations where the spreading of germs by contact is a concern. Other conventional designs, such as foot peddle activated lids, cannot be easily used by persons that may be handicapped and without use of the legs and or feet. Sensor 114 of the present invention allows hands-free operation by these persons.

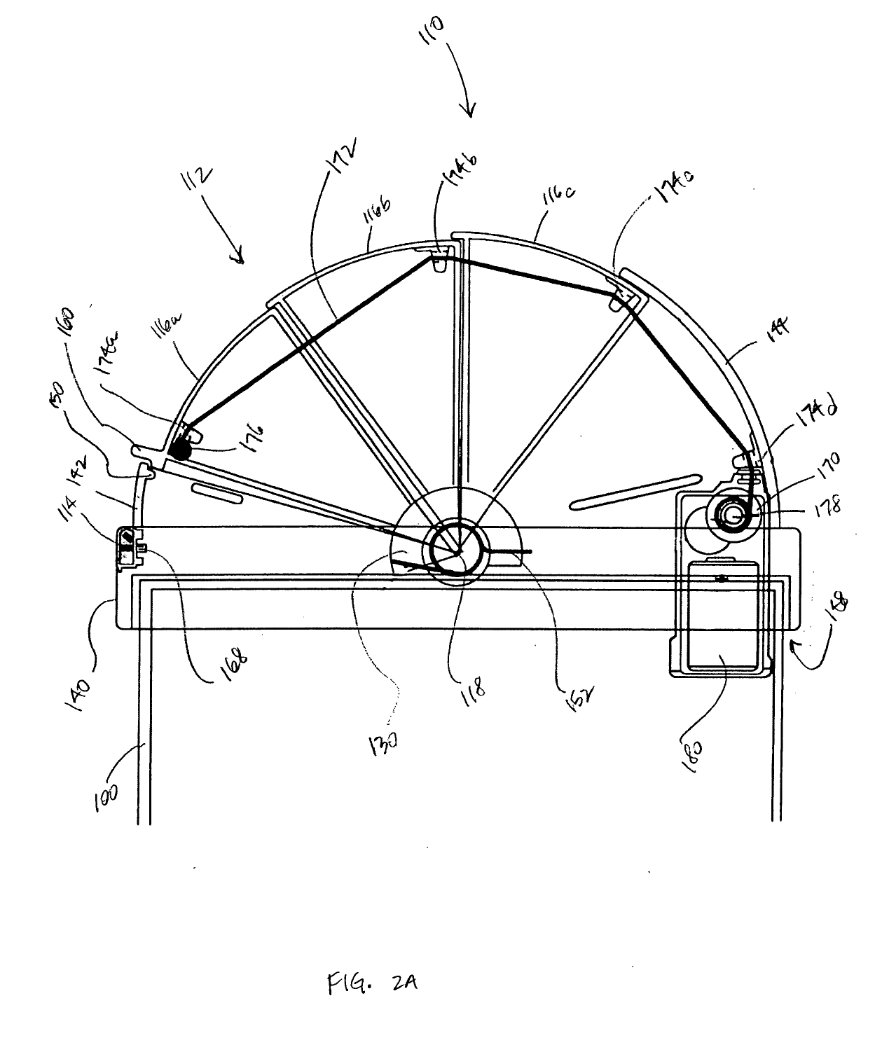

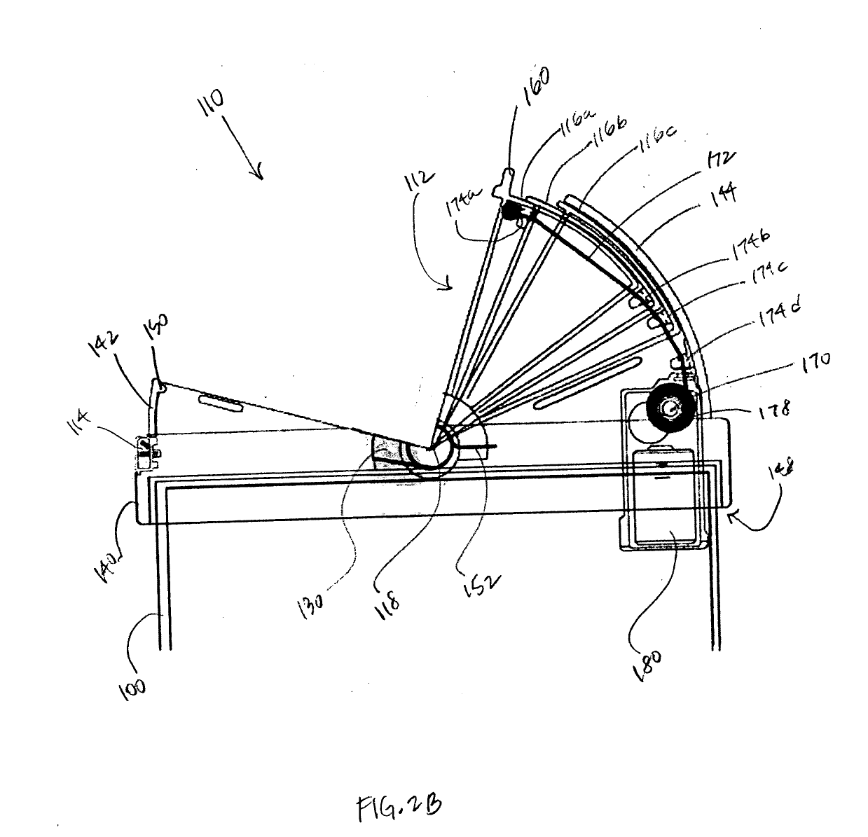

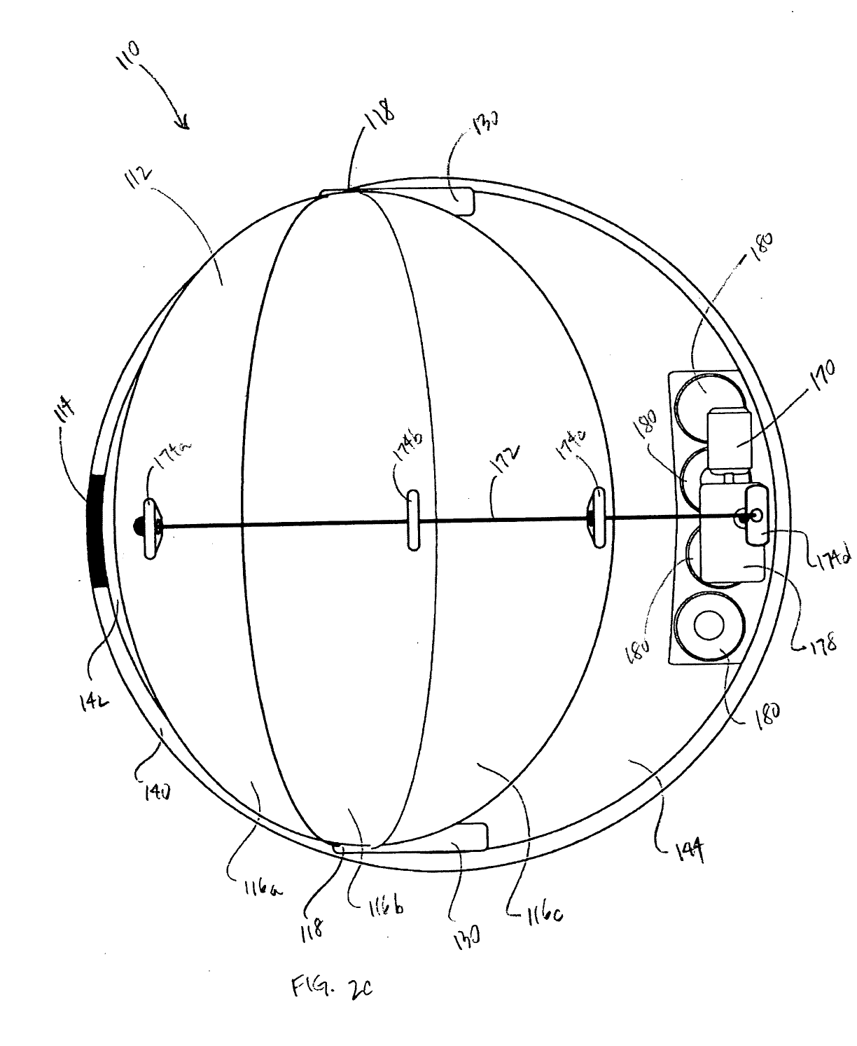

FIG. 2A is a cross-sectional side view of cover 110 with moveable member 112 in the closed position. FIG. 2B is a cross-sectional side view of cover 110 with moveable member 112 in the opened position. FIG. 2C is a top view of cover 110 with moveable member 112 in the closed position.

As shown in FIGS. 2A-2C, cover 110 includes a base portion 140 with a front portion 142 and a rear portion 144 attached to base portion 140. Pivot assembly 130 extends from base portion 140 and receives a portion of panels 116a, 116b, 116c so that panels 116a, 116b, 116c can rotate about pivot point 118 from the closed position, as shown in FIG. 2A, to the opened position, as shown in FIG. 2B. Base portion 140 includes an interior recess 148 that is adapted to receive the upper edge 124 of container 100, as shown in FIGS. 2A-2B. Front portion includes a front stop or lip 150 that receives a first panel 116a of moveable member 112 adjacent thereto. First panel 116a includes a protrusion 160 extending therefrom that rests adjacent to front stop 150 when moveable member 112 is in the closed position. As shown in FIG. 2B, rear portion 144 provides an area for positioning of panels 116a, 116b, 116c when moveable member 112 is in the opened or retracted position.

In one embodiment, first, second, and third panels 116a, 116b, 116c of moveable member 112 are connected together and attached to base portion 140 at pivot assembly 130 so as to rotate about pivot point 118 from the closed position, as shown in FIG. 2A, to the opened position, as shown in FIG. 2B. When in the opened position, panels 116a, 116b, 116c are retracted beneath and adjacent to rear portion 144 to thereby provide access to the interior of container 100. When in the closed position, panels 116a, 116b, 116c are deployed or extended to thereby prevent access to the interior of container 100.

As shown in FIG. 2A, container 100 may comprise a latch assembly 168 positioned on cover 110 that allows moveable member 112 to be secured in the closed position. Latch assembly 168 may comprise a spring loaded mechanism that latches moveable member 112 to front portion 142 of cover 110.

In one embodiment, cover 110 includes a motor 170 having an armature 172, such as, for example, a cable or string, including a coated steel cable or string, that extends from motor 170 through guides 174a, 174b, 174c, 174d of panels 116a, 116b, 116c and rear portion 144 and is attached to first panel 116a at point 176. In one aspect, a first spring 152 biases panels 116a, 116b, 116c in a direction towards front portion 142 of cover 110. When activated, motor 170 rotates in a first direction to wind armature 172 and pull panels 116a, 116b, 116c together and underneath rear portion 144 so that panels 116a, 116b, 116c move to the opened position. In one aspect, spring 152 provides tension on armature 172 so that, when motor 170 is deactivated, spring 152 rotate motor 170 in a second direction, that is opposite the first direction, to thereby move panels 116a, 116b, 116c from the opened position to the closed position. This opening and closing mechanism of container 100 provides a silent, convenient, sanitary and hands-free means for opening and closing cover 110 of container 100.

In one aspect, cover 110 including moveable member 112, by means of sliding back on itself, requires no additional space to open. Conventional trash cans and containers that open inwards use internal space and reduce the volume of the trash can or container. Other conventional cans or containers that open upwards require clear space above the can and cannot be used under short spaced counters. In addition, cover 110 including moveable member 112, by means of sliding back on itself, disturbs the air inside container 100 as little as possible. This keeps the odors within container 100. A conventional trash can and container that open inward or upwards move or fan the air inside the trash can and container bringing the odor out of the trash can and container into the room.

As shown in FIGS. 2A-2C, cover 110 includes a power supply 180 comprising, for example, one or more batteries, such as one or more “AA” sized batteries, that provide voltage and/or power to sensor 114 and motor 170 for operation thereof. It should be appreciated by those skilled in the art that power supply 180 may comprise a transformer and receptacle, such as, for example, a UL DC or UL AC/DC cord, that is adapted to receive AC voltage from a generally known electrical wall outlet and convert the receive AC voltage to DC voltage, which can then be supplied to a DC voltage regulator to provide a DC voltage to motor 170 for operation thereof. In one aspect, power supply 180, such as, for example, batteries, may be stored in an easily accessible battery compartment and replacing batteries when needed convenient and inexpensive.

In one embodiment, to open cover 110, armature 172, such as a cable, is attached to first moveable member or section 174a. As cable 172 is pulled by motor 170, first moveable member 174a pivots on pivot assembly or hinge 130 about pivot point 118 and contacts second moveable member or section 174b. As moveable members 174a, 174b are pulled, second moveable member 174b contacts third moveable member or section 174c and pulling is continued until these moveable members 174a, 174b, 174c have collapsed or retracted to rear portion 144 of cover 110. Once moveable members 174a, 174b, 174c are retracted, cover 110 is the opened position.

In one aspect, armature or cable 172 is attached to motor 170 via a pulley or spool 178 and winds up as moveable members 174a, 174b, 174c of cover 110 open, and then these moveable members 174a, 174b, 174c inversely unwind as cover 110 is closes. Motor 170 comprises, for example, an electric motor, including a high torque electric motor, that drives the pulley or spool 178 and opens cover 110. Power supply 180 is provided to operate motor 170. For example, a battery assembly can be used to provide electrical current to run motor 170. When motor 170 is activated or switched on, pulley 178 winds up cable 172 and pulls moveable members 174a, 174b, 174c of cover 110 open. When motor 170 is deactivated or switched off, pulley 178 is released, cable 172 is unwound by springs 152, and moveable members 174a, 174b, 174c are closed. In one aspect, a clutch spring can be attached to pulley 178 to add counter drag to prevent pulley 178 from unwinding too fast or too far. Stopping motion when moveable members 174a, 174b, 174c reach the closed position improves reliability.

In one embodiment, armature or cable 172, springs 152, and fasteners 222 comprise an anti-rusting material, such as, for example, stainless steel. However, it should be appreciated by those skilled in the art that this anti-rusting material may comprise various other generally known anti-rusting materials, such as plastic, resin, aluminum, etc. without departing from the scope of the present invention.

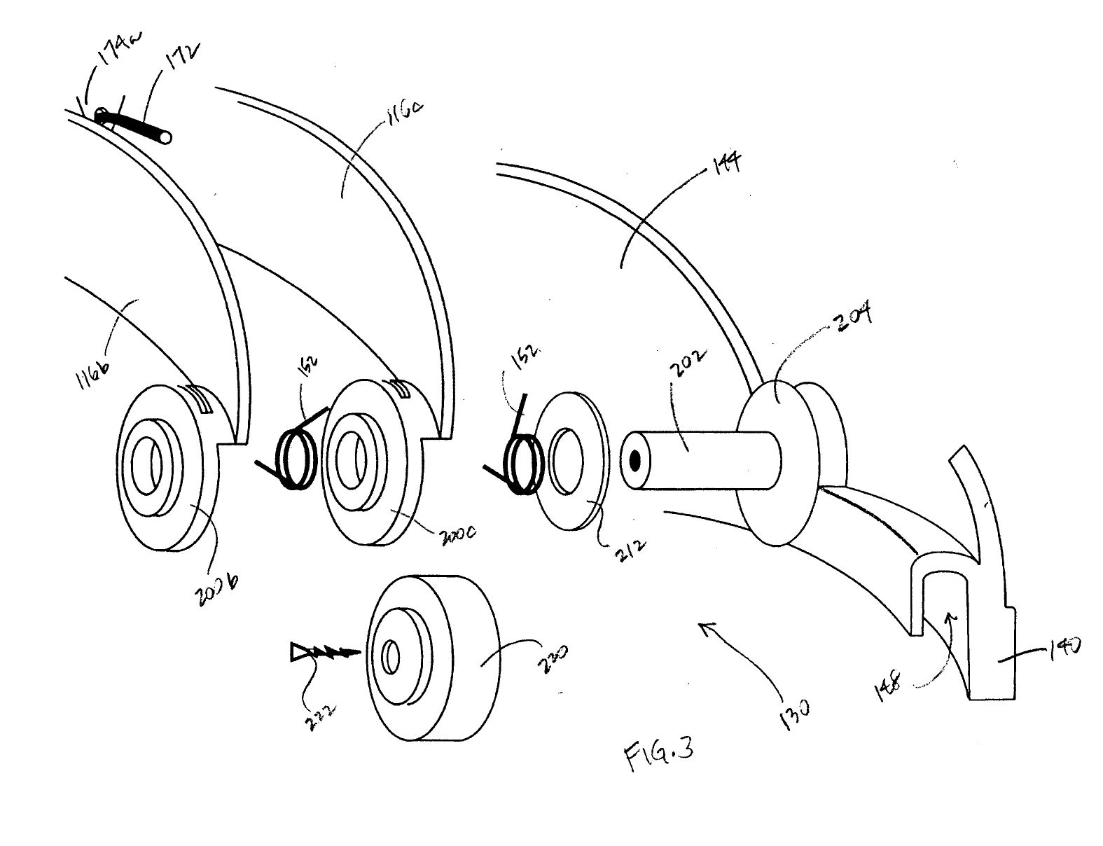

FIG. 3 is a perspective view of pivot assembly 130. As shown in FIG. 3, pivot assembly 130 includes a cylindrical shaft 202 that extends inwardly from a mounting stop 204 that protrudes from base portion 140. Each panel 116a, 116b, 116c includes at least two circular pivot portions 200a, 200b, 200c attached to lower corner portions thereof that are adapted to connect together and slide onto shaft 202 of base portion 140 so as to freely rotate thereabout. One or more springs 152 can be positioned between each pivot portion 200a, 200b, 200c so as to bias each panel 116a, 116b, 116c in a manner as previously described. In addition, pivot assembly 130 includes a cap 220 that secures each pivot portion 200a, 200b, 200c to shaft 202 via a fastener 222, such as a screw. In one aspect, a washer 212, such as a nylon washer, can be positioned between spring 152 and mounting stop 204 to prevent damage to mounting stop 204 during rotation of outer panel 116c.

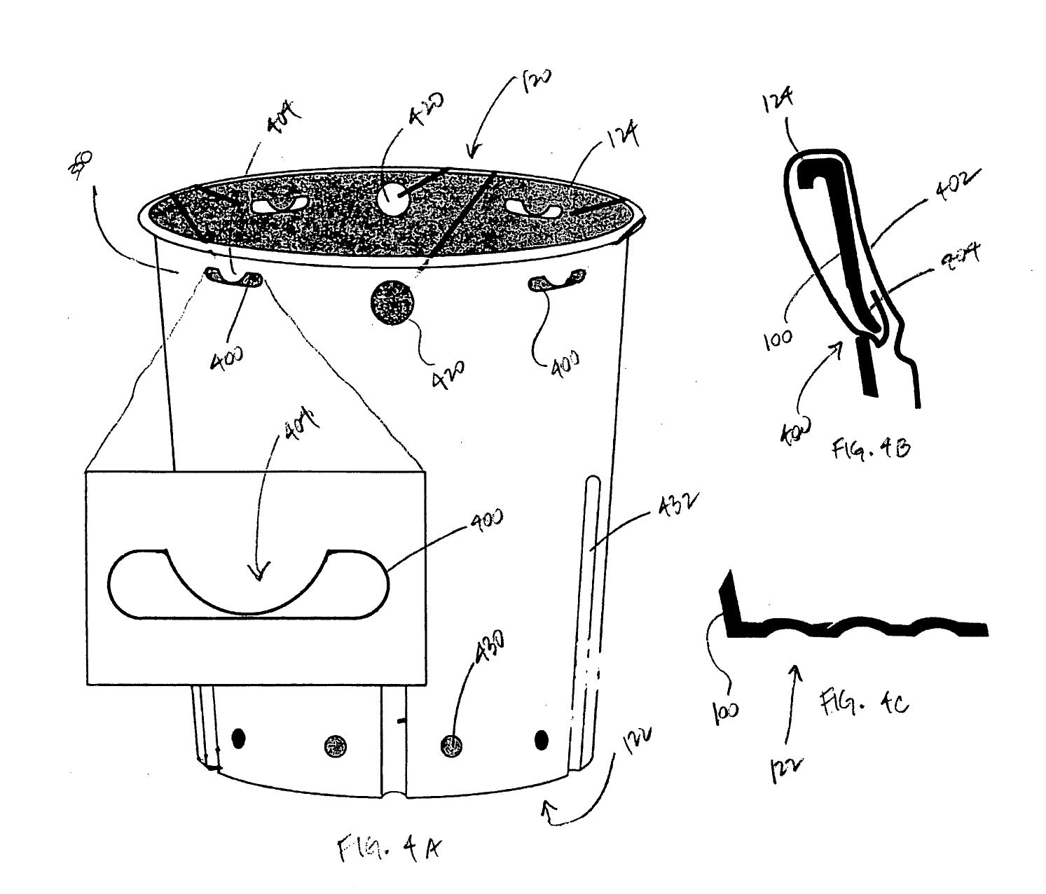

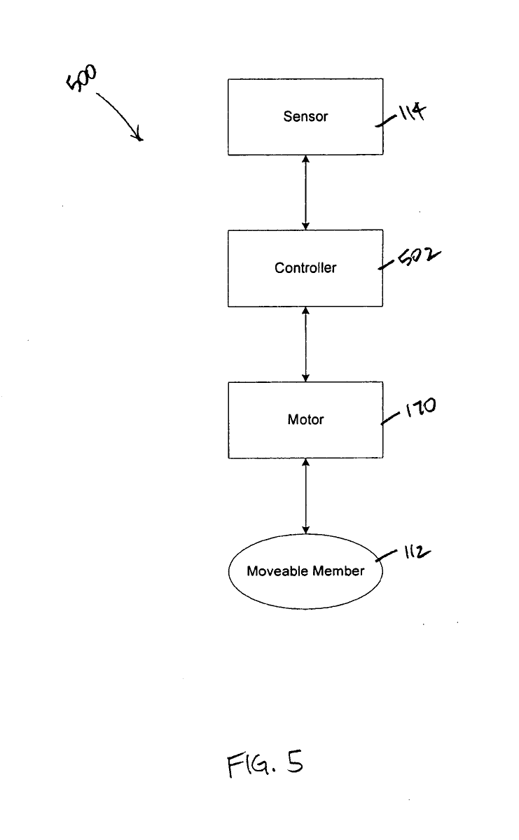

With reference to FIG. 1, cover 110, including components thereof, sits on top of container 100. In one embodiment, as shown in FIG. 4A, container 100 may include an inner container 350 that can be positioned within the interior portion of container 100. Inner container 350 includes one or more first apertures 400 that function as liner or bag securing features. As shown in FIG. 4A, first apertures 400 are formed in a side wall of inner container 350 and are adapted to receive and secure a liner or bag that is positioned within the interior portion of inner container 350. As shown in FIG. 4B, a liner or bag 402, such as, for example, a removable plastic liner or bag, can be positioned within inner container 350 so that liner 402 wraps around upper edge 124 of container 100 and is positioned through first aperture 400 and secured to container 100 via at least one clip or tab 404 that extends within first aperture 400. In one aspect, first apertures 400 are cut-out features that are cut-out of the sidewall of inner container 350 in a manner such that cut-out bag clip 404 extends within the cut-out region formed when first apertures 400 are cut-out.

In one embodiment, as shown in FIG. 4A, container 100 includes one or more second and third apertures 420, 430. Second apertures 420 function as lift-out handles that allow container 100 to be lifted from the interior region of container 100 and moved around by a user. In one aspect, lift-out handles 420 are formed and positioned on each side of inner container 350, and each lift-out handle 420 comprises a diameter large enough to accommodate a user's hand for holding and lifting inner container 350 from container 100. Third apertures 430 function as breather holes that prevent liner or bag suction. In one aspect, breather holes 430 comprise a diameter of approximately ¼″ to prevent liner 402 or bag suction when liner 402 is placed in inner container 350.

In one embodiment, inner container 350 includes one or more grooves 432 formed on an exterior surface of inner container 350 to prevent inner container 350 from sticking or adhering to the interior of container 100 when positioned within container 100. In addition, the one or more grooves 432 provide for easier and/or more convenient liner 402 or bag removal.

FIG. 4C is a cross-sectional side view of closed end 122 of inner container 350. In one embodiment, closed end of container 100 comprises ringed ridges that appear as circles within circles having diameters that decrease from the outer portion to the inner portion of closed end 100. As shown in FIG. 4C, the ringed ridges of closed end 122 comprise a corrugated cross-sectional shape that provides improved strength for inner container 350.

It should be appreciated that container 100 including components thereof, such as cover 110 and moveable member 112, can be formed of a high strength rigid material, such as plastic, metal, or various other generally known materials. In one aspect, container 100 comprises a stand alone container that can be placed on the ground or under a countertop.

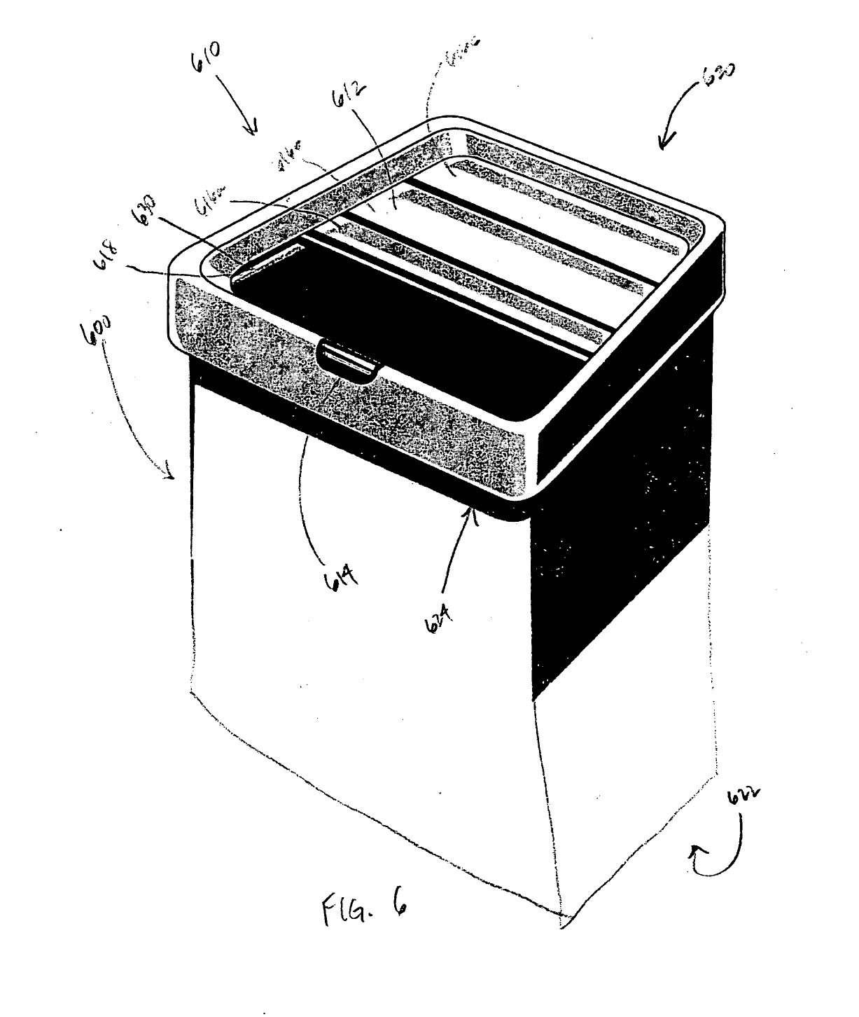

FIG. 5 is a diagram of a control system 500 for container 100. Control system 500 comprises sensor 114, a controller, circuit or processor 502, such as, for example, a smart chip, motor 170, and moveable member 112 of cover 110. Cover 110 includes moveable member 112 and motor 170 having armature 172 connected to moveable member 112. Sensor 114 generates a sensing signal when motion is detected. For example, when an object or a user, such as a person, is detected moving in front of or adjacent to sensor 114, this motion or movement generates and transfers a sensing signal to controller 502 for processing. Controller 502 is connected to sensor 114 and motor 170 such that controller 502 receives the sensing signal from sensor 114 and activates motor 170 to move moveable member 112 from a closed position to an opened position. In one aspect, after a predetermined period of time, controller 502 deactivates motor 170 to allow springs 152 to move moveable member 112 of cover 110 from the opened position to the closed position. Moreover, power supply 180 is connected to controller 502 to provide voltage and/or power to controller 502 for operation thereof.

In one general aspect of the present invention, the basic function of control system 500 is to open cover 110 when an object or user is sensed or detected, keep cover 110 open as long as this object or user is sensed or detected, and close cover 110 when the object or user moves away. When an object or user is detected by sensor 114, sensor 114 generates and sends a sensing signal to controller 502 to switch motor 170 on. After activation, motor 170 runs and opens moveable member 112 of cover 110. Motor 170 will hold moveable member 112 in the opened position as long as sensor 114 senses or detects the presence of the object or user in a target area proximate to sensor 114. When the target area is clear, sensor 114 will no longer send a sensing signal to controller 502. At this time, controller 502 will pause for an approximate period of time, such as, for example, 1.5 seconds, and then controller will switch motor 170 off. When motor 170 is switched off, the bias or tension of springs 152 will close cover 112.

In one aspect, sensor 114 checks for motion or movement at a predetermined interval, such as, for example, every 0.5 seconds. To activate motor 170, controller 502 sends an activation signal to motor 170. This activation signal may comprise a predetermined voltage that controller 502 applied to motor 170. To deactivate motor 170, controller 502 no longer sends the activation signal to motor 170.

In one aspect, motor 170 can be switched on with a push button switch (not shown) on cover 110. For the case of hands-free use, sensor 114, such as, for example, a cads light sensor, can be used to detect the presence of an object or user in proximity to container 100 that sends a sensing signal to controller, processor or control integrated circuit (IC) 502, which activates motor 170 to run and continue to run as long as a presence is detected by sensor 114. After sensor 114 no longer detects an object, control IC 502 waits, for example, 1.5 seconds and then deactivates motor 170. Sensor 114 and control IC 502 can be powered by power supply 180. Alternately, a remote power supply, such as a UL DC or UL AC/DC cord can be used.

In one aspect, container 100 of the present invention provides effortless hands-free convenience and does not require a user to touch or step on a portion of container 100 prior to discarding waste, trash or debris. Since touching container 100 may lead to the spread of bacteria, contaminants and infectious diseases, container 100 of the present invention is more sanitary than conventional trash cans and containers. A user can wave their hand in front of sensor 114 to activate motor 170 and open moveable member 112 of cover 110. This opening of moveable member 112 of cover 110 can be achieved, for example, in approximately 1 second. Subsequently, closing of moveable member 112 of cover 110 can be achieved, for example, 1.5 seconds. It should be appreciated by those skilled in the art that these opening and closing times can be shortened or extended without departing from the scope of the present invention.

It should be appreciated by those skilled in the art that the container of the present invention includes manual releases and open buttons to allow the user to manually operate the cover and moveable member to gain access to the interior portion of the container.

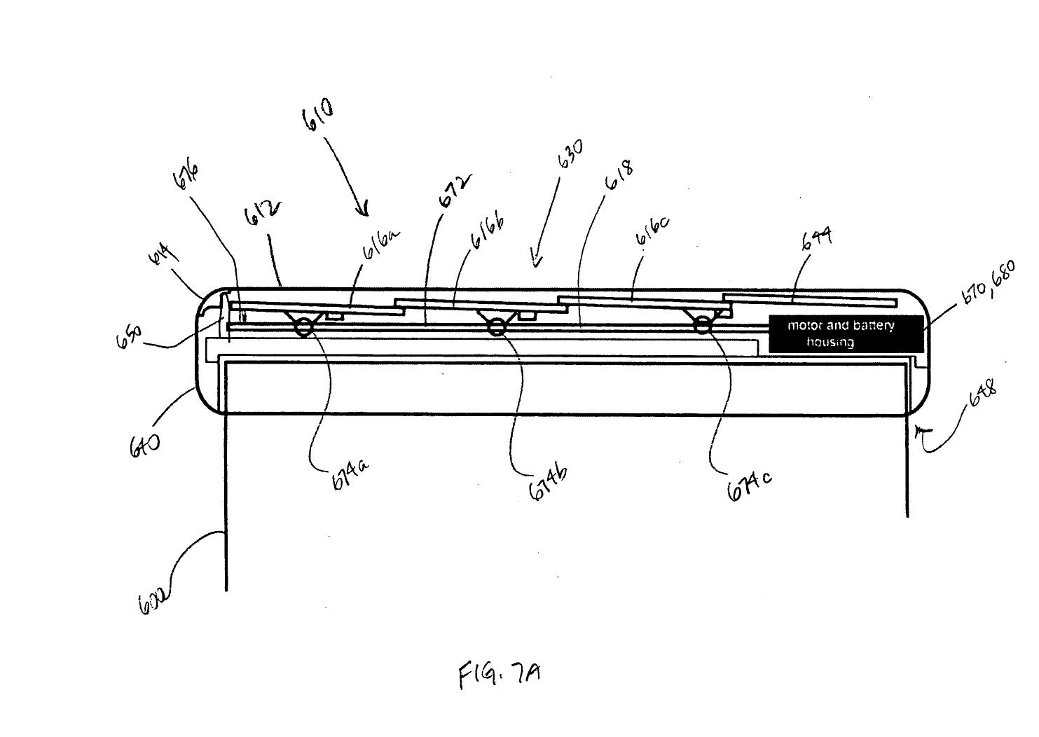

FIG. 6 is a perspective view of a container 600, such as, for example, a trash container, having a cover or lid 610 with a moveable member 612 and a sensor 614. In one embodiment, container 600 comprises a rectangular shape with a hollow interior region, an open end 620, and a closed end 622. Open end 620 is adapted to allow a trash liner or bag to be positioned within container 600, and open end 620 is also adapted to receive cover 610 around an upper edge 624 of container 600. Closed end 622 encloses container 600 at the bottom to prevent trash and debris from exiting container 600 from the bottom, and closed end 622 is typically positioned adjacent to the floor or ground to provide a stable base that allows container 600 to stand upright as shown in FIG. 1. In one embodiment, cover 610 and moveable member 612 comprise a rectangular or cubical-box shape.

It should be appreciated by those skilled in the art that container 600 may comprise various types of general purpose containers, such as, for example, a trash container having the automatic opening feature without departing from the scope of the present invention.

In one embodiment, moveable member 612 comprises one or more moveable panels 616a, 616b, 616c that are connected to a guide assembly 630 and slide along a guide 618 from a closed or deployed position to an opened or retracted position, as shown in FIG. 6, to thereby provide an opening or access to the hollow interior region of container 600. Moveable member 612, including moveable panels 616a, 616b, 616c, can also slide along guide assembly 6308, which provides guide 618, from the closed position to the open position, as shown in FIG. 1, to thereby seal or cover the opening or prevent access to the hollow interior region of container 600.

In one embodiment, sensor 614 comprises a motion sensor or detector that is adapted to sense or detect motion or movement adjacent to or in front of container 600 at a position adjacent to or in front of sensor 614.

In another embodiment, guide 618 may comprise a recessed groove formed in an interior portion of cover 610. This recessed groove is adapted to receive an outer peripheral portion of moveable member 612, including panels 616a, 616b, 616c. As shown in FIG. 6, panels 616a, 616b, 616c are flat and rectangular in shape.

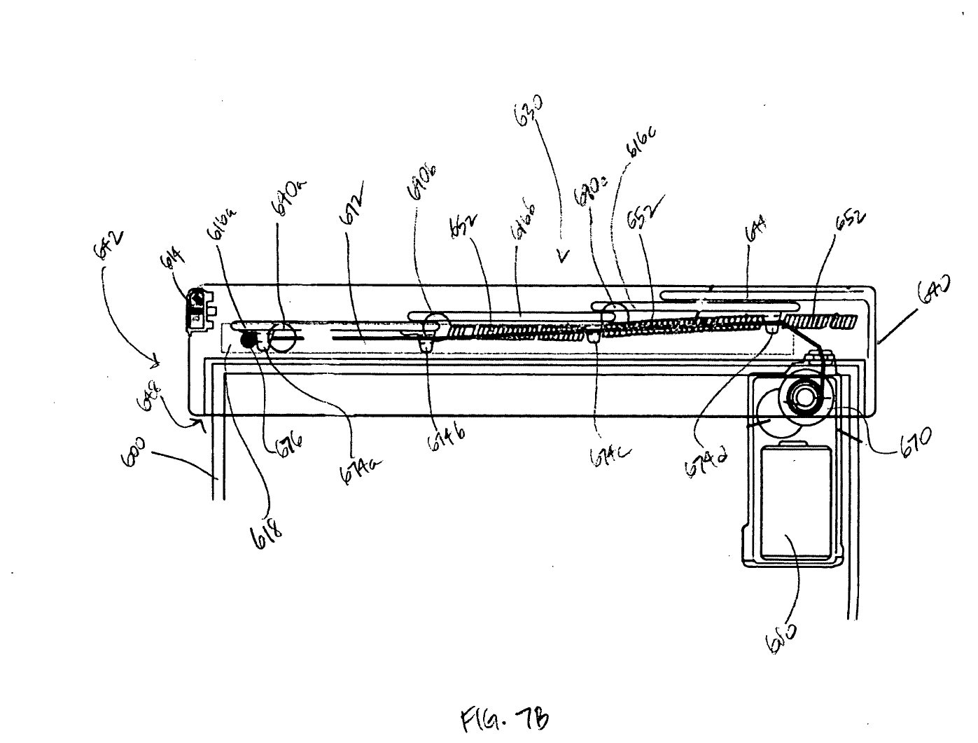

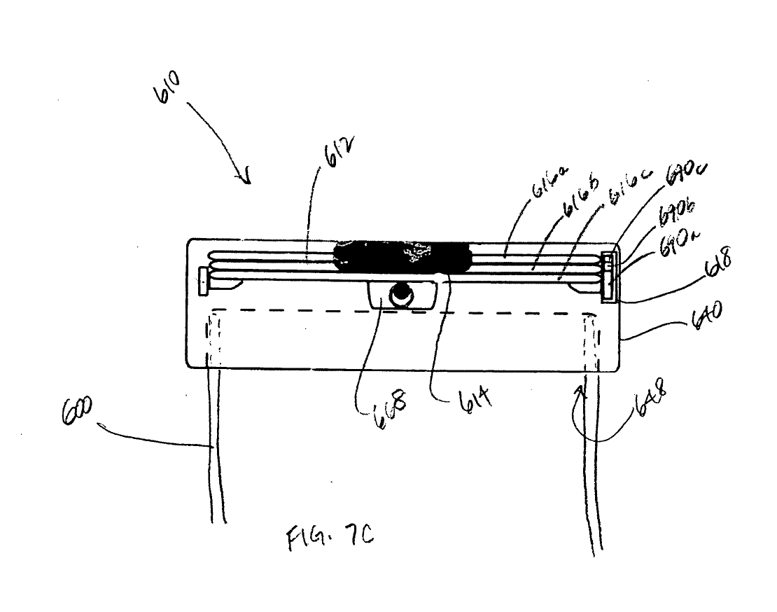

FIGS. 7A-7B are cross-sectional side views of cover 610 with moveable member 612 in the closed position. FIG.7C is a front view of cover 610.

As shown in FIGS. 7A-7C, cover 610 includes a base portion 640 with a rear portion 644 attached to base portion 640. Guide assembly 630 extends along an interior portion of base portion 640 and receives a portion of panels 616a, 616b, 616c so that panels 616a, 616b, 616c can slide along guide 618 from the closed position, as shown in FIG. 7A, to the opened position. Base portion 640 includes an lower interior recess 648 that is adapted to receive the upper edge 624 of container 600, as shown in FIGS. 7A-7B. Front portion includes a front stop 650 that receives a first panel 616a of moveable member 612 adjacent thereto. First panel 616a rests adjacent to front stop 650 when moveable member 612 is in the closed position. In one aspect, rear portion 644 provides an area for positioning of panels 616a, 616b, 616c when moveable member 612 is in the opened or retracted position.

In one embodiment, first, second, and third panels 616a, 616b, 616c of moveable member 612 are connected together and attached to base portion 640 at guide assembly 630 so as to slide along guide 618 from the closed position, as shown in FIG. 7A, to the opened position. When in the opened position, panels 616a, 616b, 616c are retracted beneath and adjacent to rear portion 644 to thereby provide access to the interior of container 600. When in the closed position, panels 616a, 616b, 616c are deployed or extended to thereby prevent access to the interior of container 600.

In one embodiment, cover 610 includes a motor 670 having an armature 672, such as a cable or string, that extends from motor 670 through guides 674a, 674b, 674c, 674d of panels 616a, 616b, 616c and is attached to first panel 616a at point 676. In one aspect, as shown in FIG. 7B, springs 652 bias panels 616a, 616b, 616c in a direction towards front portion 642 of cover 610. When activated, motor 670 rotates in a first direction to wind armature 672 and pull panels 616a, 616b, 616c together and underneath rear portion 644 so that panels 616a, 616b, 616c move to the opened position. Springs 652 provides tension on armature 672 so that, when motor 670 is deactivated, springs 652 rotate motor 670 in a second direction, that is opposite the first direction, to thereby move panels 616a, 616b, 616c from the opened position to the closed position.

As shown in FIGS. 7A-7B, cover 610 includes a power supply 680 comprising, for example, one or more batteries, such as “D” sized batteries, that provide voltage and/or power to motor 670 for operation thereof. It should be appreciated by those skilled in the art that power supply 680 may comprise a transformer and receptacle that is adapted to receive AC voltage from a generally known electrical wall outlet and convert the receive AC voltage to DC voltage, which can then be supplied to a DC voltage regulator to provide a DC voltage to motor 670 for operation thereof.

In one embodiment, as shown in FIG. 7B, guide wheels 690a, 690b, 690c may be attached to each panel 616a, 616b, 616c of moveable member 612 that track down the side of guide 618 of base member 640 to prevent binding of panels 616a, 616b, 616c when moveable member 612 is opening and closing.

As shown in FIG. 7C, container 600 may comprise a latch assembly 668 positioned on cover 610 that allows moveable member 612 to be secured in the closed position. Latch assembly 668 may comprise a spring loaded mechanism that latches moveable member 612 to front portion 642 of cover 610.

The container of the present invention can be sized, in any proportion, for practical placement in an office, a hospital, hotel and/or a home including a kitchen, bathroom, nursery, workshop, garage, etc.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A container comprising:
a cover having a moveable member;
a motor having armature connected to the moveable member;
a sensor that generates a sensing signal when motion is detected; and
a controller connected to the sensor and the motor, the controller receives the sensing signal from the sensor and activates the motor to move the moveable member from a closed position to an opened position.

2. The container of claim 1, wherein, after a predetermined period of time, the controller deactivates the motor to move the moveable member from the opened position to the closed position.

3. The container of claim 1, wherein the moveable member rotates about a pivot point when moving from the closed position to the opened position.

4. The container of claim 3, wherein the moveable member comprises a plurality of moveable sections that are connected to a pivot assembly and rotate about the pivot point when moving from the closed position to the opened position.

5. The container of claim 4, wherein when in the closed position, each moveable section includes at least one edge that overlaps at least one edge of an adjacent moveable section to form a sealed cover.

6. The container of claim 4, wherein when in the opened position, each moveable section overlaps an adjacent moveable section to form an aperture in the cover.

7. The container of claim 1, wherein the moveable member slides along a guide when moving from the closed position to the opened position.

8. The container of claim 1, wherein the sensor comprises a motion sensor that detects movement of an object within a predetermined sensing range.

9. The container of claim 1, wherein when activated, the motor rotates to wind armature and move the moveable member from the closed position to the opened position.

10. The container of claim 1, wherein one or more springs bias the moveable member in the closed position.

11. The container of claim 10, wherein the one or more springs provide tension on the armature so that, when the motor is deactivated, the one or more springs rotate the motor from the open position to the closed position.

12. The container of claim 1, wherein the armature comprises a cable or string.

13. The container of claim 1, wherein the container comprises a trash container.

14. The container of claim 1, wherein the container comprises a container selected from the group consisting of a fishing tackle live well, a diaper pail, a sharps container and a general purpose container.

15. The container of claim 1, further comprising a power supply that provides voltage or power to the sensor, controller and motor for operation thereof.

16. The container of claim 1, further comprising an inner container positioned within an interior portion of the container and the cover sits on top of the container and inner container, wherein the inner container includes one or more apertures formed in a side wall thereof that are adapted to receive and secure a liner or bag that is positioned within an interior portion of the inner container.

17. A cover for a container comprising:
a moveable member;
a motor having armature connected to the moveable member;
a sensor that generates a sensing signal when motion is detected; and
a controller connected to the sensor and the motor, the controller receives the sensing signal from the sensor and activates the motor to move the moveable member from a closed position to an opened position.

18. The cover of claim 17, wherein, after a predetermined period of time, the controller deactivates the motor to move the moveable member from the opened position to the closed position.

19. A method of opening a cover for a container comprising:
sensing motion within a predetermined sensing range;
generating a sensing signal upon sensing motion within the predetermined sensing range;
activating a motor having armature connected to a moveable member of the cover to thereby move the moveable member from a closed position to an opened position.

20. The method of claim 19, further comprising deactivating the motor after a predetermined period of time to thereby move the moveable member of the cover from the opened position to the closed position.
